(19) United States
(12) Patent Application Publication
(10) Pub. No.: US 2010/0235229 A1
(43) Pub. Date: Sep. 16, 2010

(54) CONTENT DISTRIBUTION SYSTEM, MANAGEMENT APPARATUS, AND MOBILE TERMINAL

(76) Inventor: Akihiro HATAYAMA, Hachioji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/722,133

(22) Filed: Mar. 11, 2010

(30) Foreign Application Priority Data
Mar. 12, 2009 (JP) 2009-059728
Jun. 1, 2009 (JP) 2009-132294
Mar. 4, 2010 (JP) 2010-048336

(51) Int. Cl. G06F 15/16; G06Q 20/00; G06Q 30/00; H04L 9/32; G06Q 40/00; G06Q 99/00; G06Q 50/00

(52) U.S. Cl. 705/14.16; 705/26; 705/34; 709/203; 713/168

(57) ABSTRACT

A management apparatus includes a collector configured to collect requests of events of which the distribution is required via the network from users of the plurality of terminals, a list generator configured to aggregate the collected requests for each event to generate a list, a disclosure unit configured to disclose the list on a site on the network for a predetermined period, a reception unit configured to receive a request for distributions from a plurality of content distributors via the site for each content included in the list, a selector configured to select a content distributor to which a distribution right is granted from among the plurality of content distributors for each content included in the list based on a predetermined conditions, and a reporter configured to report a selection result by the selector to content distributor with the distribution right granted thereto.

### CROSS-REFERENCE TO RELATED APPLICATIONS

This application is based upon and claims the benefit of priority from prior Japanese Patent Applications No. 2009-059728, filed Mar. 12, 2009; No. 2009-132294, filed Jun. 1, 2009; and No. 2010-048336, filed Mar. 4, 2010, the entire contents of all of which are incorporated herein by reference.

### BACKGROUND OF THE INVENTION

1. Field of the Invention

One embodiment of the invention relates to a content distribution system configured to distribute video content to an unspecified number of viewers, and a management apparatus and a mobile terminal of the system.

2. Description of the Related Art

A systems distributing video content via an IP network such as the Internet has become well known. The capacities of lines connecting between a broadcast station and each user have become large year by year, and the qualities of the lines have become high. Further, as a new mobile broadband line such as a worldwide interoperability for microwave access (WiMAX) has been constructed, a foundation capable of providing a service with a new style has been prepared.

An event-outside broadcast such as a concert, or a sports-outside broadcast is a representative broadcast content. In the present circumstances, since a television station selects the content based on its unique standard, it is hard to say that the content desired by individual viewers has been distributed. That is, according to the selection standards depending on the conventional audience rating is apt to select averaged content, the content has to be narrowed into items having relatively big names such as baseball games and soccer games, and relay carriers have been restricted in those items.

In recent years, content has become viewed from moving image distribution sites on the Internet. However, even this kind of techniques, it is impossible for general viewers to view sportscast relay and event-cast relay desired to be viewed thereby. A technique aiming the creation of digest video with the preferences of the viewers reflected thereto is disclosed in Jpn. Pat. Appln. KOKAI Publication No. 2004-112110. However, even by this technique disclosed in the document given above, there is a limit to a degree reflecting the preferences of the viewers. Because it is impossible to promote motivation to produce a various items of content to the relay carriers.

As mentioned above, most of the sportscast relays and event-cast relays have been unilaterally selected by the television stations to broadcast them, the relays individually desired by the general viewers are extremely restricted. Since the number of the relay carriers is limited, and the relay carriers have to take account of intentions of the broadcast stations; it becomes further hard to relay the events not having big names. The content relay carriers have to select announcers, cameramen, and commentators among from those belonging to the television stations, it is impossible to say that there are true competitions. Therefore, the viewers may not satisfy with the improvement in skill of the relay carriers, and may heartily enjoy the distributed content.

### BRIEF SUMMARY OF THE INVENTION

One embodiment of the invention is invented under the situations given above, an object of the invention is to provide a content distribution system, a management apparatus, and a mobile terminal configured to further satisfy viewers.

According to the invention, there is provided a content distribution system comprising a terminal of a content distributor configured to distribute content to a network, a plurality of terminals configured to receive and reproduce content distributed on a network by the content distributor, and a management apparatus configured to perform operation management of the content, wherein the management apparatus comprises: a collector configured to collect requests via the network from users of the plurality of terminals, the requests is requests of events of which the distribution is required; a list generator configured to aggregate the collected requests for each event to generate a list; a disclosure unit configured to disclose the list on a site on the network for a predetermined period; a reception unit configured to receive a request for distributions from a plurality of content distributors via the site for each content included in the list; a selector configured to select a content distributor to which a distribution right is granted from among the plurality of content distributors for each content included in the list based on a predetermined conditions; and a reporter configured to report a selection result by the selector to content distributors with the distribution rights granted thereto.

According to the invention, there is provided a management apparatus connected to a plurality of terminals configured to receive and reproduce content distributed on a network by a content distributor and perform operation management of the content comprising: a collector configured to collect requests via the network from users of the plurality of terminals, the requests is requests of events of which the distribution is required; a list generator configured to aggregate the collected requests for each event to generate a list; a disclosure unit configured to disclose the list on a site on the network for a predetermined period; a reception unit configured to receive a request for distributions from a plurality of content distributors via the site for each content included in the list; a selector configured to select a content distributor to which a distribution right is granted from among the plurality of content distributors for each content included in the list based on a predetermined conditions; and a reporter configured to report a selection result by the selector to content distributor with the distribution right granted thereto.

According to the invention, there is provided a mobile terminal which is connectable to a management apparatus configured to perform operation management of content distributed on the network by a content distributor, via the network, comprising: a request transmitter configured to transmit a request to the management apparatus, the request is a request of an event of which the distribution is required; a key acquisition unit configured to acquire, from the management apparatus, key information for descrambling content to be scrambled and distributed; and a decoder configured to decode the content by using the acquired key information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an exemplary system view depicting an outline of a content distribution system regarding a first embodiment of the invention;

FIG. 2 is an exemplary functional block diagram of a Web server depicted in FIG. 1;

FIG. 3 is an exemplary view depicting an example of a Web page disclosed by the Web server;

FIG. 4 is an exemplary sequence view depicting an example of a flow of processes in the content distribution system of the first embodiment of the invention;

FIG. 5 is an exemplary system view depicting an outline of an existing television (TV) broadcast system for a comparison;

FIG. 6 is an exemplary system view depicting an outline of a content distribution system regarding a second embodiment of the invention;

FIG. 7 is an exemplary functional block diagram of a Web server depicted in FIG. 6;

FIG. 8 is an exemplary functional block diagram of a mobile terminal depicted in FIG. 6;

FIG. 9 is an exemplary sequence view depicting a processing procedure regarding listening to content at the mobile terminal of the second embodiment of the invention;

FIG. 10 is an exemplary functional block diagram of a Web server regarding a third embodiment of the invention; and

FIG. 11 is an exemplary sequence view depicting an example of a flow of processes in the content distribution system of the third embodiment of the invention.

### DETAILED DESCRIPTION OF THE INVENTION

### First Embodiment

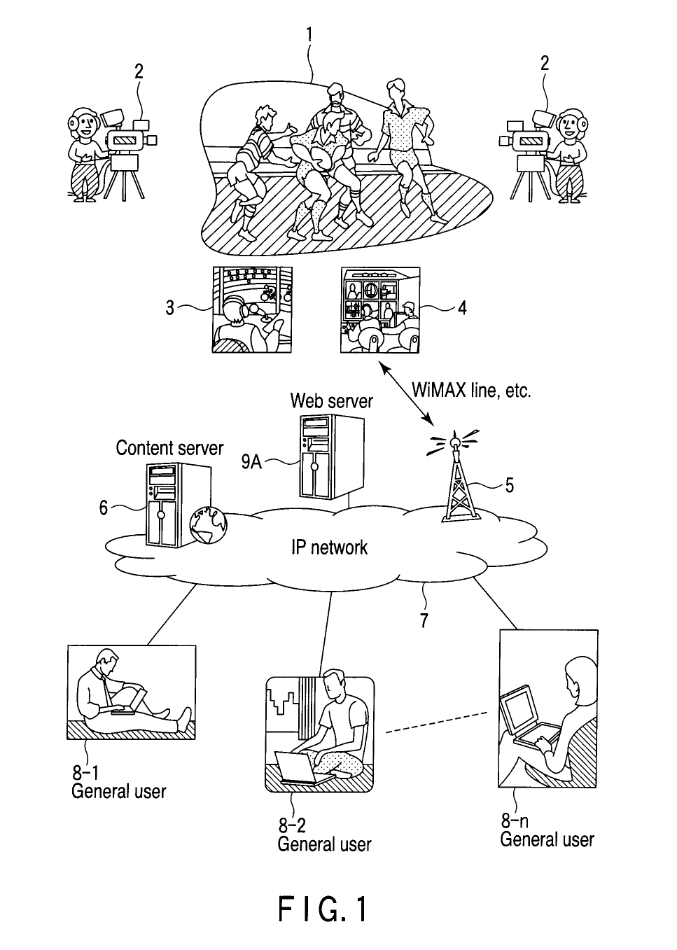

FIG. 1 shows a system view illustrating an outline of a content distribution system regarding a first embodiment of the invention. In FIG. 1, the situation in an event hall 1 in which a game of a sport is taken place is imaged by a camera man 2, edited in an editing room 4 as a content distributor by adding voices of an announcer and a commentator 3, and content to be relayed or distributed is created. The content is immediately broadcasted or distributed to general users 8-1 to 8-n by directly passing through an IP network 7 from a base station 5 for WiMAX. Moreover, the content is broadcasted or distributed only to registered general users 8-1 to 8-n through IP network 7 by a following method. The following method is using a distribution server and passing streaming data by a unicast to the registered general user 8-1-8-n. Here, a distribution server is a part of function of content server 6. Moreover, a unicast is distributing data to general users 8-1 to 8-n from a distribution server by 1:1.

That is, from the site of the event, the content is flown onto the IP network 7 via the WiMAX, etc. The distributed content may be recorded once in a content server 6, and may be distributed on demand in response to requests from the general users 8-1 to 8-n. The general users 8-1 to 8-n views the content from television terminals or personal terminals owned by them. While the first embodiment has described in a manner that the term “distribution” and the term “relay” have almost the same meaning, more particularly, the term “relay” means immediacy, but the term “distribution” is used as a term having an on-demand character.

Meanwhile, the system shown in FIG. 1 includes a Web server 9A connected to the IP network 7. In this first embodiment of the invention, the Web server 9A performs a variety of items of processing. The Web server 9A may be managed by a relay carrier, a broadcast station contracting for a content distribution business, or an operation company contracting management business, or may be managed by an enterprise independent from these foregoing parties.

In this first embodiment of the invention, the content server 6 and the Web server 9A may be managed by an operation company as a management apparatus.

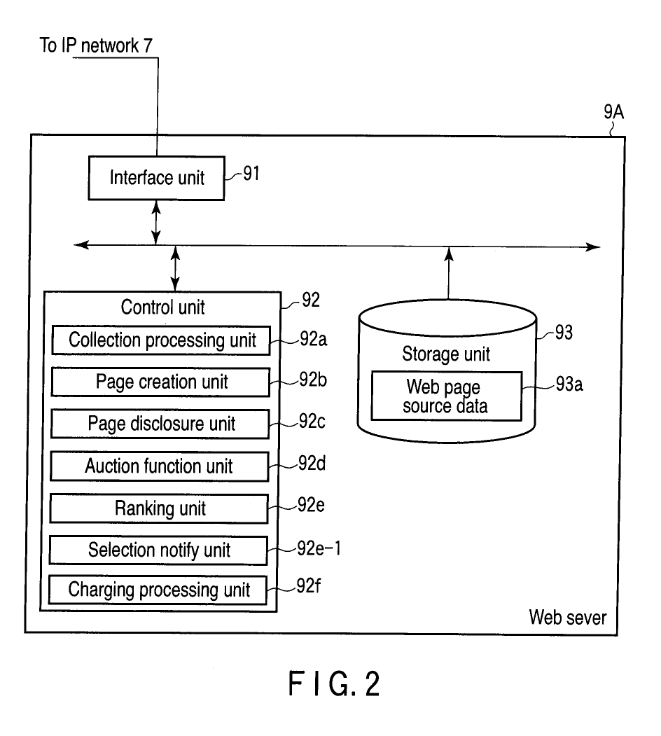

FIG. 2 is a functional block diagram of the Web server 9A. The Web server 9A has a function as a so-called Web site, and has an interface unit 91 to be connected to the IP network 7, a control unit 92 having a computation processing function by a central processing unit (CPU), and a storage unit 93 such as a large capacity memory.

The control unit 92 includes a collection processing unit 92a as a collection unit, a page creation unit 92b as a list generator, a page disclosure unit 92c as a disclosure unit, an auction function unit 92d as a reception unit, a ranking processing unit 92e as a selector, a selecting notify unit 92e-1 as a reporter and a charging processing unit 92f as a processing function regarding the first embodiment.

The collection processing unit 92a collects events of which the distribution is required from the general users 8-1 to 8-n in forms of event requests. That is, the terminals of the users 8-1 to 8-n have access functions to access the Web server 9A via the IP network 7, and send, to the Web server 9A, the requests in forms of text data or Web voting. The collection processing unit 92a collects evaluations on the distributed content, in a form, for example, of the Web voting via the IP network 7.

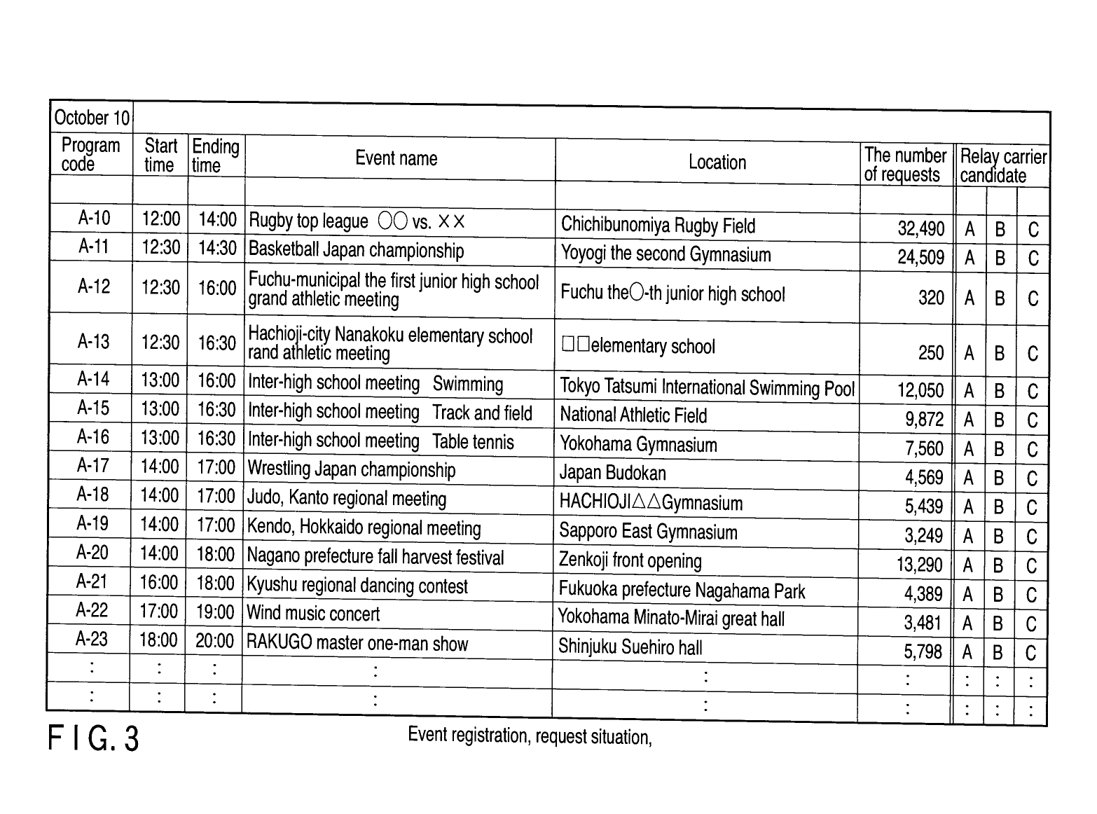

A page creation unit 92b aggregates the collected requests to make a list thereof, and creates a Web page shown in FIG. 3. The source code data on the Web page is stored in the storage unit 93 as Web page source data 93a. This Web page is disclosed by the page disclosure unit 92c on the IP network 7 for a predetermined period. All the content providers and other carriers as well as the general users 8-1 to 8-n can access the Web page.

FIG. 3 shows a view illustrating one example of a Web page to be disclosed by the Web server 9A. The Web page is disclosed, for example, over an entry period of an event. In FIG. 3, for every date (October 10, in FIG. 3) program codes, start times, ending times, names of events, locations, the number of requests from general users, and candidates for relay carriers for the scheduled events are displayed in a list.

That is, the page creation unit 92b has a function of putting program codes for each event, aggregating the number of requests, candidates for the relay carriers, etc., of the events based on the requests collected from the general users 8-1 to 8-n, and making up a list to create the Web page source data 93a. The user and the carriers who have referred to the Web page can know the situations of the registration of the requested events and the situations of the requests.

The order of the candidates for the relay carriers in FIG. 3 is determined, for example, by counting the evaluations, as points, obtained by the general users 8-1 to 8-n depending on the previous relay results, and by arranging in descending order of the point levels. According to the order, the distribution rights of content may be granted. The order can be ascertained at the time when the carriers request the content distribution, and the order is immediately reflected for the display content on the Web page.

The auction function unit 92d accepts the request for the content distribution from a plurality of carriers for each item of program content expressed on the Web page of FIG. 3 via the Web site. The auction function unit 92d selects one carrier based on conditions accompanied by the request for the content distribution, for example, based on the price for acquiring the distribution right. That is, the auction function unit 92d sets the distribution right by associating with the program code, and accepts a tender, in an auction form from each carrier, for the distribution right.

The distribution right is granted to the carrier who has presented the cheapest price for an entry period. After the entry period and when the successful carrier is decided, the fact is reported to the successful carrier. For reporting the fact, the fact may be disclosed on the Web site, or the fact may be reported only to the successful carrier by a secret message.

The ranking processing unit 92e statistically processes the evaluations of the distribution content collected by the collection processing unit 92a, and ranks the carriers based on the processing result. The processing result is disclosed, for example, on the Web page of FIG. 3. That is the order, forming a line of names of carriers (A, B . . . ) shown as the candidates for the relay carriers, corresponds to the ranking. For instance, it is suitable to show the ranking in a manner that the rank of the carrier who is positioned at the left-most side is the highest one, and the ranking drops as the positions go to right side.

The selecting notify unit 92e-1 reports a selection result by the ranking processing unit 92e to content distributors with the distribution rights granted thereto.

The charging processing unit 92f charges the users who have viewed the content. Next, operations of the configuration given above will be described.

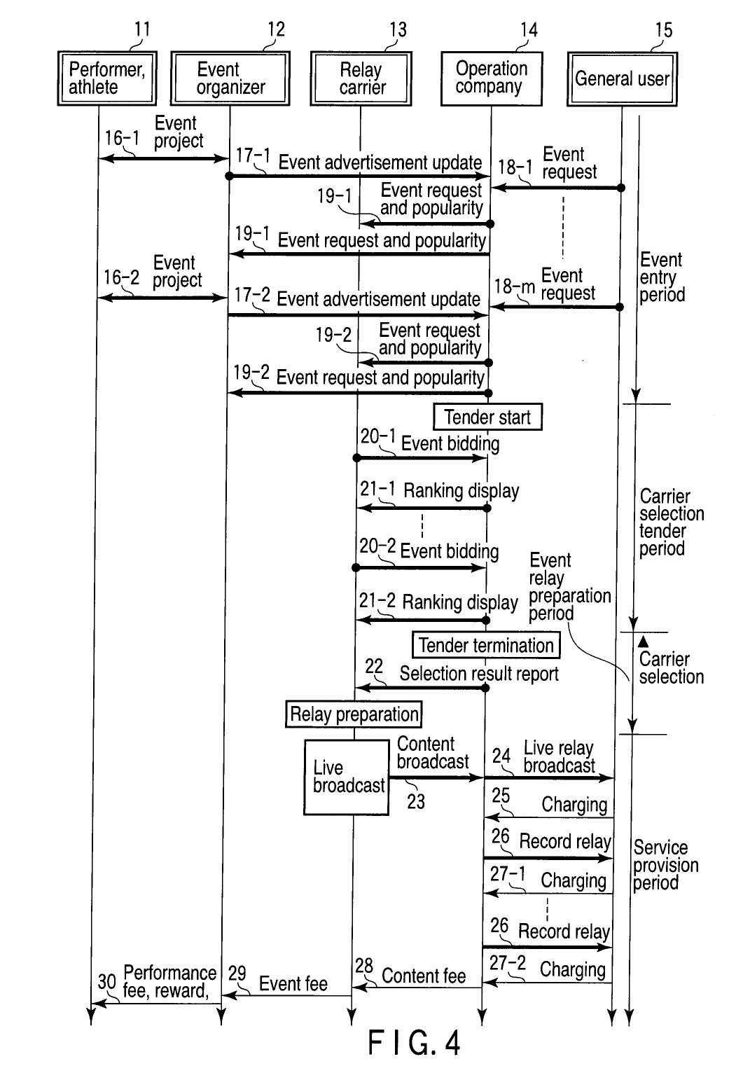

FIG. 4 shows a sequence view illustrating one example of a flow of processing in the content distribution system of FIG. 1. FIG. 4 shows one example of a business flow to be performed in a manner in which a performer and an athlete 11, an organizer 12 promoting each event, a relay carrier 13 producing content, an operation company 14 of a content provider, and general users 15 are associated with one another in the content distribution business.

In FIG. 4, the organizer 12 lobbies for the performer and athlete 11 to project an event. The lobbying may be performed directly to the performers, etc. 11, and may transmit/receive messages via the IP network 7 (16-1, 16-2). When the event is projected, an event advertisement update message (17-1) reports the fact to the operation company 14. The operation company 14 registers the intention of performing the projected event in the Web server 9A, and the content of the event is immediately reflected to the Web page (FIG. 3).

Meanwhile, general users 15 report requests for events and programs desiring to be broadcasted to the operation company 14 by means of event requests (18-1 to 18-m). The aggregation result of the requests (18-1 to 18-m) is registered in the Web site, and disclosed from the Web page. The general users 15 who have browsed this Web page can similarly enhance needs (popularity degrees) of the events by repeating event requests if event content agreeing with the events is displayed.

While monitoring the degrees of popularities (popularity degrees) for the events (19-1, 19-2), the organizer 12 of some event projects in accordance with the requests from the general users 15. The projected content is similarly registered in the Web site as event advertisements (17-1, 17-2).

The procedure in this way is performed before a fixed period in which the event is actually performed passes, and both the users and carriers can confirm the popularity degree of the event. Next, the tender for selecting a relay carrier relaying the event is performed.

Various ways for the tender are considerable. For instance, as mentioned above, a money amount getting a contract to relay business may be set as a tender price, and a relay carrier presenting the lowest price may be decided as a successful carrier for a distribution right. Or, statistically processing the evaluations, by the users 15, obtained from the previous relay results to evaluate by points, and may grant the distribution right of the event in descending order of point accumulation count values.

In FIG. 4, when the tender is started, the carriers desiring the event relay express their requests by means of the bidding (20-1, 20-2), and the ranking of the bidding is disclosed on the Web site (21-1, 21-2). The reference of the ranking of the carriers may be bidding money amounts, or evaluation points. When the tender period has passed, the tender is terminated; the operation company 14 can know which relay carrier has granted the distribution right of the event by monitoring the Web page. The carrier who has been granted the distribution right is reported the fact by a selection result report message (22).

When the carrier selection is terminated, the relay carrier 13 who has been granted the distribution right to relay the content prepares for information of an announcer, a commentator, a background of the event, and performers, history research of athletes, camera work at the relay, etc., and prepares for actual event relay.

When the event is held, broadcast content (23) is broadcasted or distributed to the general users 15 via the IP network 7. Moreover, the content is broadcasted or distributed only to registered general users 8-1 to 8-n through IP network 7 by a following method. The following method is using a distribution server and passing streaming data by a unicast to the registered general user 8-1-8-n. Here, a distribution server is a part of function of content server 6. Moreover, a unicast is distributing data to general users 8-1 to 8-n from a distribution server by 1:1. Although the distribution form is basically live broadcast, the form may be on-demand distribution through the content server 6. That is, the general users 15 not only can view the content through actual live broadcast (24) but also can view the content from the content server 6 when they feel like it.

The operation company 14 grasps the number of the viewers for each item of content. More practically, the general users 15 register themselves in the distribution system in advance, and then, the operation company 14 grasps that from what time to what time in the content broadcast hour the users 15 have viewed the content based on their login hours. Thereby, the operation company 14 can calculate indexes indicating whether or not the users 15 get bored with the content in midstream, this indexes are reflected to the points of the carriers.

Comparing the advance popularity degree of the event with the number of actual viewers enables the comparison result to be used as one of items of the evaluation data of the relay carrier 13. For instance, if the number of the viewers is small even though the carrier has been ballyhooed, there is possibility that the event itself or the carrier 13 has a problem. In such a case, the operation company 14 should degrade the evaluation point of the carrier 13 who has contracted for the content distribution, and otherwise, the operation company 14 should promote the carrier 13.

The users 15 who have viewed the content are charged, for example, with metered rate charging for each actual live broadcast, or for recorded broadcast (25, 27-1, and 27-2). The operation company 14 gathers once the fees charged from the users 15, and pays a content fee (28) to the relay carrier 13, an event fee (29) to the event organizer, performance fees and rewards (30) for the performers and athletes 11, respectively. That is, depending on the aggregation result of the number of the viewers after the end of the event, the operation company 14 pays the content fee (28) to the relay carrier 13, and the relay carrier 13 pays a part of a cost as the event fee (29) to the event organizer 12. Further, the event organizer 12 pays the performance fees and rewards (30) to the performers and the athletes 11 from among the money amount, including entrance fees of attendances, other than the fees due to the broadcast. Thus, the rewards depending on the provided services are distributed to each party and person.

To care for the cost to be appropriated to the operation of the business given above, maintaining a function of charging, as audience fees, the audience fees to the general users 15 via the IP network 7, or covering by advertisement fees from general enterprises is a possible approach. In a case of charging as the audience fees from the general users 15, it may be necessary to take the way of charging only a case where the users 15 view the content for a time longer than a fixed time from a viewing start time into consideration.

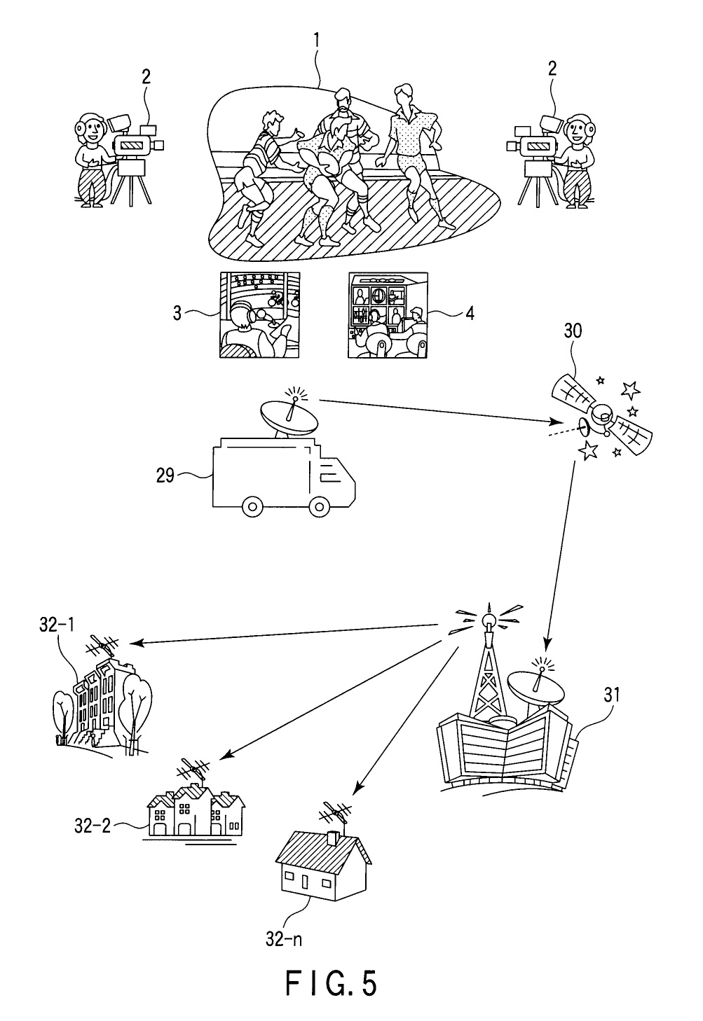

FIG. 5 shows a system view illustrating an outline of an existing television broadcast system for a comparison. The aspect of the event 1 imaged by the camera man 2 is edited in the editing room 4 by adding the voices of the announcer and commentator 3, and broadcast content is created. The broadcast content is broadcasted from a broadcast material transfer vehicle (SNG) 29 to end users 32-1, 32-2 to 32-n via a communication satellite 30 and a broadcast station 31. Since such a system is employed, the system can not reflect the desire of general users.

Conversely, in the first embodiment of the invention, the content distribution system enables general users, who have personally registered in advance together with fee payment information, etc., to report viewing requests for the scheduled sportscast relay and event-cast relay to the operation company 14. The requests are aggregated on the system side, and disclosed on the Web page. Further, the first embodiment becomes possible also preparing the function to also collect the information indicate relay carrier who users 15 want to act as intermediary. Since the users 15 can also report requests to the relay carrier 13 by incorporated temporarily the function, it is expected to improve the skill by the effort of the relay carrier.

The relay carrier 13 can determine which of the sportscast relays and the even-cast relays are desired, or whether or not content being proud of is desired based on disclosed information, and subscribe the tender in an auction form. Or at the time of the tender, the comprehensive ranking of the relay carriers is disclosed in accordance with the requests for the relay carriers from the general users 15 and with the previous relay results, the relay carriers 13, in the descending order of the ranking, can select the events for relaying. The relay carrier 13 who has been granted the right of the content distribution prepares the relay in the event hall, prepares the announcer and the commentator, and prepares the line of the IP network 7 to relay the content live. The content is recorded in the content server 6, and on-demand distribution also can be performed.

Further, since the relay carrier 13 is statistically evaluated by points based on the information collected from the viewers to be reflected onto the Web page, the evaluation can be feedback to the ranking at the next tender. The fee of the viewing of the content by the viewer is electrically settled in accordance with the viewing hour, the fee becomes an income for each enterprise by distributing to the operation company 14, the relay carrier 13, and the event organizer 12.

In this way, the general users 15 can request not to an event unilaterally decided by the broadcast station, but to an event-cast relay desiring to view. By enhancing the evaluation points, since the relay carrier 13s can obtain motivation to enable selecting advantageous event-cast relays, the relay carriers 13 can expect to improve their skills according to the element of competition among the carriers. The sports and events having less opportunities to be relay-broadcasted can have more opportunities to be relay-broadcasted, and various sports are promoted. Moreover, new kinds of business setting out the event-cast relay business can be developed; this makes a contribution to an increase in employment in a society.

Both the general users 15 and the carriers 13 can approach the result of the aggregation of the requests. The carriers 13 can expect high rewards as the number of the requests from the general users becomes large, and requests to perform relay broadcast become enhanced. Conversely, if the number of requests is small, the requests to perform the relay broadcast become lowered, and there is a possibility that the relay broadcast itself is not performed. Even if the number of requests from the general users 15 is small, increasing the burden on the costs of per one the general users 15 possibly satisfies the business requests of the relay carriers. In this way, according to the first embodiment of the invention, the development of flexible business in consideration of a case in which the existing TV broadcast may be performed.

As mentioned above, according to the first embodiment of the invention, when the requests from the general users 15 are collected, and if the collected requests highly meet the needs, even if the requested events only have relatively small names, the general users 15 can view the events. It is possible for the relay carriers 13 to strongly reflect the requests of the general users 15, as the requests from the general users 15 have become speeded, an increase in the number of the relay carriers 13 can be expected. This situation causes the increase in the number of announcers and the commentators for the sportscast relays and since not only the creation of employment but also the improvement in skill can be expected depending on the expansion of the range, the improvement in quality of broadcast content is further expected. More specifically, the distribution system can cultivate announcers who are good at relays for each type of sports, cultivate excellent commentators from among specific sport experiences, and contribute to spread and promote sports themselves.

Further, for example, in sportscast relays, since only popular sports such as baseball and soccer can conventionally be object of the TV relay broadcast, the sports relay broadcast cannot attract a lot of attentions to other sports. Conversely, according to the first embodiment of the invention, the general user also request for sports not having big names, some relay carriers responds to these requests, so that the general users can view the sportscast relays at anytime and then differentials between types of sports can be improved.

As described above, in the first embodiment of the invention, the general users 15 make requests for the events that the users 15 want to view to the Web server 9A owned by the operation company 14. The Web server 9A aggregates the requests to disclose the result on the Web page. Other general users who have browsed the Web page similarly make requests so that reflect the aggregation result onto the Web page in sequence. The relay carriers 13 who have browsed the Web page presents a business price to the Web server 9A according to the determination based on the indexes of the number of requests, etc., and their own financial power, etc. and makes the successful bit in an auction form for the right of the content distribution. Thereby, the contribution system can separate between the relay carriers and the broadcast station, satisfy the viewer's needs, and enhance the motivation for the relay carriers. Thus, it is possible to provide a content distribution system configured to further satisfy the viewers.

The invention is not limited to the specific details and a representative embodiment shown and described herein. For instance, the first embodiment has described about the broadcast content produced through the live relay broadcast such as the event-cast relay of sports. The invention is not limited to the embodiment, it is possible to perform TV broadcast according to the requests from the general users while including the content in which all programs, such as education programs, interview programs and quiz programs which have been edited, produced and broadcasted only by the broadcast station.

FIG. 4 shows a form in which the event organizer 12 makes advertisements. As a substitution for this, the relay carriers 13 may have initiatives for event advertisements. That is, the relay carriers 13 may uniquely organize the event; design an idea for content attracting viewer's interest, and project in a scale according to their own financial power. As shown in FIG. 4, since the distribution system is primarily configured that the requests and the popularity degrees for the events are reported to the relay carriers 13, the relay carriers 13 can create attractive content with reference to the requests and the popularity degrees.

In other words, it is clearly desired to grant the selection right for the content also to the relay carriers 13 without remaining in a business style in which the operation company 14 mediates the relationship between the demand and the supply between the general users 15 and the event organizer 12. If quite a new relay carrier enters content distribution business accompanied by a new concept and a feeling and show its ability, things turn out to advantage to the general users and also lead to a useful aspect in respect to creation of a new culture. It is possible not only for the event organizer 12 and the relay carriers 13 but also for the performers and the athletes 11 or the general users 15 to produce original content charge-free, advertise themselves and freely perform if they go though the Web server 9A.

As described above, the first embodiment can enhance the degree of satisfaction of the viewers and also can take advantages of easing to distribute their own content of unspecified majority.

According to the first embodiment, the performers 11, the event organizer 12, and the relay carriers 13 can receive the money amount of the awards in response to the evaluations of the content; thereby it is expected to promote their requests to create the content.

### Second Embodiment

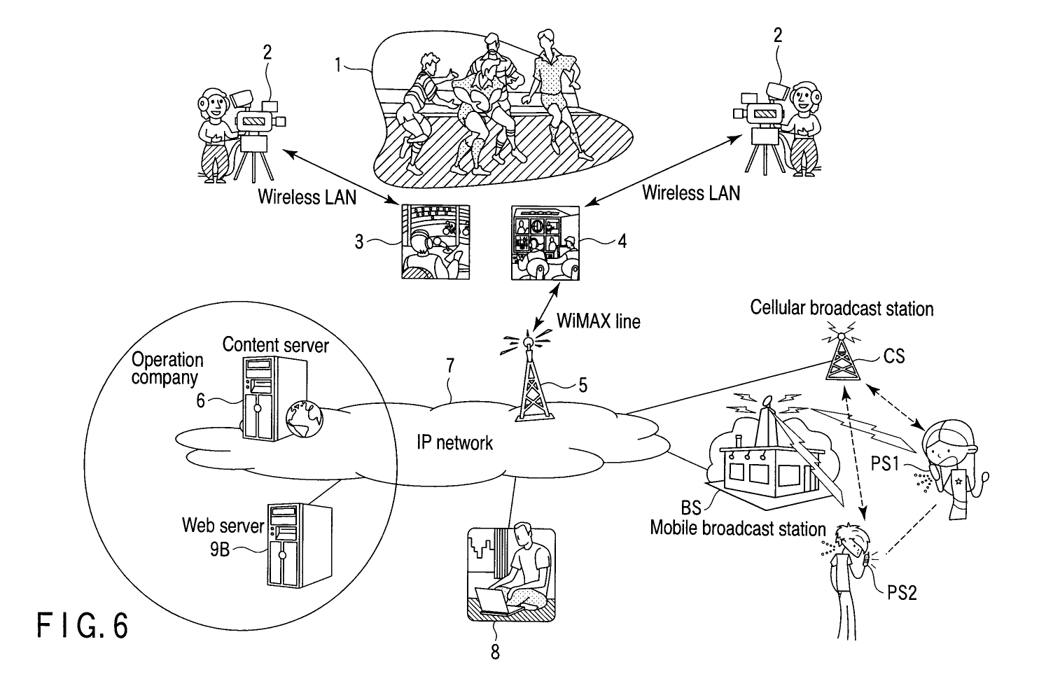

FIG. 6 shows a system illustrating an outline of a content distribution system regarding a second embodiment of the invention. In FIG. 6, the same components as those of FIG. 1 are designated by identical symbols and the detailed description will be omitted.

In FIG. 6, an aspect in the event hall 1 in which games of sports, etc., are held is imaged by the camera man 2, the image is edited in the editing room 4 by adding the voices of the announcer and the commentator 3, and the content for the relay or the distribution is created. The content is distributed from the base station for the WiMAX 5 to the PC user 8 and mobile terminals PS1, PS2 by directly passing though the IP network 7. The user of each terminal device views the distributed content.

Using a large-capacity line such as a WiMAX enables the content of live broadcast to flow from a site of an event into the IP network 7. The viewers can view the distributed content by using the terminal devices owned by the users. The distributed content may be recorded once in the content server 6, and may be distributed on demand in response to the requests from the general users 15. The content server 6 may be managed by the relay carriers 13 contracting the content distribution business, by the broadcast station, by the operation company 14 contracting management businesses, or by an enterprise independent of those enterprises given above.

By the way, the system of FIG. 6 includes a Web server 9B, a mobile broadcast station BS, and a cellular base station CS, and all of them are connected to the IP network 7. The PS1, PS2 owned by the users are connected to the cellular base station CS to enable them to perform interactive communication, and also enable them to acquire moving image content transmitted from the mobile broadcast station BS. That is, the mobile broadcast station BS distributes the content to be distributed via the IP network 7 toward the mobile terminals PS1, PS2. The mobile broadcast station BS has a function of scrambling the content to be distributed toward the mobile terminals PS1, PS2 via the IP network 7 and keeping a secret of the distributed content within the radio section on the IP network 7. Key information for descrambling the scrambling is managed by an encryption key management unit in the Web server 9B.

In this second embodiment of the invention, the content server 6, the Web server 9B, the mobile broadcast station BS and the cellular base station CS may be managed by an operation company as a management apparatus.

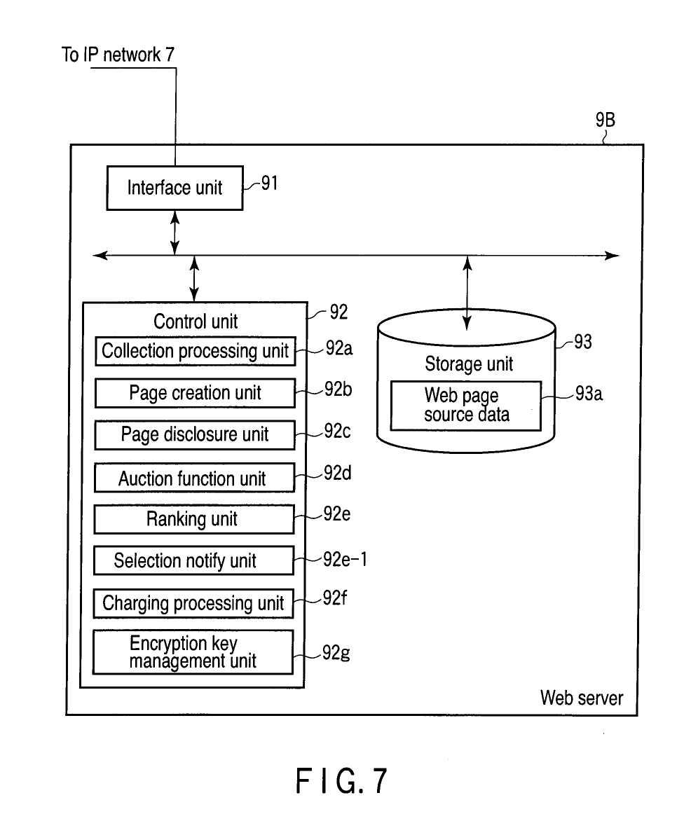

FIG. 7 shows a functional block diagram of the Web server 9B. In FIG. 7, the same components as those of FIG. 2 are designated by identical symbols and the detailed description will be eliminated.

The control unit 92 of the Web server 9B further has an encryption key management unit 92g as a processing function regarding the second embodiment of the invention.

The collection processing unit 92a collects the event requests transmitted from the PC user 8 or the mobile terminals PS1, PS2. The collection processing unit 92a collects the evaluations of the distributed content, for example, in Web voting manner via the IP network 7.

The page creation unit 92b aggregates the collected requests for each event to make a list, and creates the Web page shown in FIG. 3. Source code data of the Web page is stored in the storage unit 93 as Web page source data 93a. The Web page is disclosed by the page disclosure unit 92c on the IP network 7 for a predetermined period. The content distribution enterprise and all of other enterprises as well as the PC user 8, and the mobile terminals PS1, PS2 can access the Web page.

The page creation unit 92b has a function of adding a program code for each event based on the requests collected from the PC user 8, aggregating the number of the events and the candidates of the relay carriers to put together in a table, and creating the Web page source data 93a. The users and the carriers who have referred to the Web page can recognize the situation of registration of the desired events and the situation of the requests.

The auction function unit 92d accepts a request for content distributions from a plurality of carriers via the web site for each item of program content shown on the Web page. The auction function unit 92d selects one carrier based on conditions accompanied by the expression of the will, for example, the price for obtaining the distribution right. That is, the auction function unit 92d sets the distribution right by associating with the program code, and accepts the bit for the distribution right from each carrier in an auction form.

The ranking processing unit 92e statistically processes the evaluation points for the distributed content collected by the collection processing unit 92a to rank the carriers based on the processing result. The ranking result is disclosed, for example, on the Web page of FIG. 3. Namely, the order of names of carriers (A, B . . . ) shown as the candidates of the relay carriers correspond to the ranking. For instance, the rank of the carrier positioned at the left-most is the best rank; the ranking may be shown so that the ranks gradually get lower toward the right.

The charging processing unit 92f performs charging processing to the viewers who have viewed the content. Especially, the charging processing unit 92f acquires reception situation of the content from the mobile terminals PS1, PS2 with the distribution of the content received thereon. The reception situation can be shown, for example, as the total of the time periods in which the content can be viewed among the distribution period of the content, or the ratio of the time periods thereof. In the mobile terminals PS1, PS2, since the reception situations of electric waves varies every second due to the movement, excellent images cannot be always obtained for the entire of the distribution period. Then, in the second embodiment of the embodiment, the mobile terminal manages the reception situation to report the situation to the Web server 9B after the end of viewing. The charging processing unit 92f charges the user of the mobile terminal PS1, PS2 that is the acquisition source of the reception situation, for example, with metered rate charging in response to the reception situation obtained from the mobile terminal. Thereby, the system can achieve paper view for the content viewing by the mobile terminal.

The encryption key management unit 92g stores key information for descrambling the scrambling to the distributed content scrambled by the mobile broadcast station BS, and reports the key information (decryption key) only to the mobile terminal that is an authorized recipient via the IP network 7. The decryption key is reported by e-mail, for example, prior to the distribution of the content to the mobile terminal which has required the content distribution. For instance, the code showing the decryption key may be described in a text on the e-mail, or an execution file may be attached to the e-mail so as to automatically download the decryption key by clicking the icon of the file.

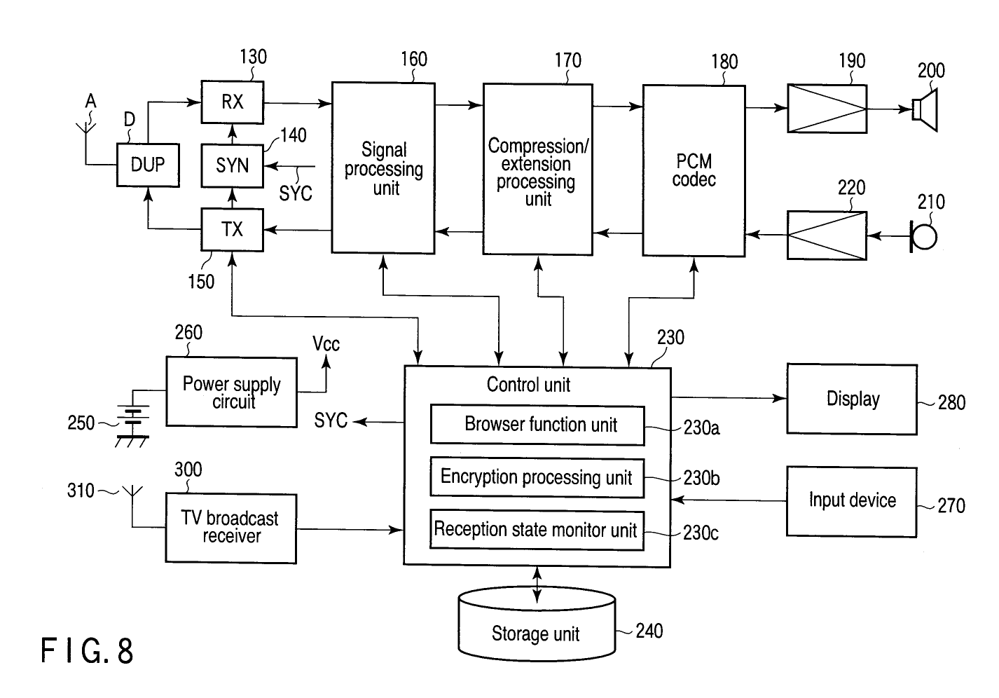

FIG. 8 shows a functional block diagram of each of the mobile terminals PS1, PS2. The radio signal transmitted from the cellular base station CS is received by an antenna A and then input to a reception circuit (RX) 130 via an antenna duplicator (DUP) D. The reception circuit 130 mixes the received radio signal with a local oscillation signal output from a frequency synthesizer (SYN) 140 to frequency-convert into an intermediate signal. The intermediate signal is demodulated and a reception baseband signal is output. The frequency of the local oscillation signal generated by the synthesizer 140 is instructed by a control signal SYC output from a control unit 230.

The reception baseband signal is input to a signal processing unit 160, and reception packet data in a predetermined transmission format is reproduced. The reception packet data is input in a compression extension processing unit 170 (referred to as a processing unit 170). The processing unit 170 separates the reception packet data output from the signal processing unit 160 for each medium. The processing unit 170 decodes the packet data for each separated medium. For instance, in a speech mode, the processing unit 170 decodes audio data such as speech voice included in the packet data by means of a speech codec. If video data is included in the packet data as is in a television telephone mode, the processing unit 17 decodes the video data through a video codec.

The digital audio signal obtained through the decoding processing is supplied to a PCM code processing unit (referred to as a PCM codec) 180. The PCM codec 180 PCM-decodes the digital audio signal output from the processing unit 170 to output an analog audio signal. The analog audio signal is amplified by a reception speech amplifier 190 and then output from a loudspeaker 200.

The digital video signal decoded by the processing unit 170 is input to the control unit 230. The control unit 230 displays the digital video signal output from the processing unit 170 on a display 280 through a video RAM. The control unit 230 displays not only the received video data but also the video data imaged with a camera (not shown) on the display 280 through the video RAM.

If the reception packet data is the data downloaded from an e-mail or a Web site, the received data is input from the signal processing unit 160 to the control unit 230. The control unit 230 stores the input reception data in a reception data storage area of a storage unit 240, and also displays the reception data on the display 280 in response to a display operation of a user by an input device 270.

Meanwhile, in the speech mode, the voice signal of a speaker input in a microphone 210 is amplified up to an appropriate level by means of a transmission speech amplifier 220 and then made into the digital audio signal by being applied PCM coding processing through the PCM codec 180, and input to the processing unit 170. The video signal output from the camera (not shown) is digitalized by the control unit 230 to be input to the processing unit 170. The e-mail generated by the control unit 230 is also input to the processing unit 170 from the control unit 230.

The processing unit 170 generates audio data by encoding the digital audio signal. The processing unit 170 encodes the digital video signal output from the control unit 230 to generate the video data. Further, when the e-mail is output from the control unit 230, the processing unit 170 encodes the txt data, etc. The processing unit 170 pocketsizes the decoded audio data, video data and the text data, etc., by means of a multi separation unit in accordance with the predetermined transmission format to output the transmission packet data to the signal processing unit 160.

The signal processing unit 160 processes the transmission packet data output from the processing unit 170 and then outputs to a transmission circuit (TX) 150. The TX 150 generates a transmission signal based on the transmission packet data from the signal processing unit 160, for example, in a modulation system such as a quadrature phase shift keying (QPSK) system, an orthogonal frequency division multiplex (OFDM) system, etc., based on the transmission packet data from the signal processing unit 160. The signal processing unit 160 synthesizes the generated transmission signal with the local oscillation signal generated from the frequency synthesizer 140 to frequency-convert into the radio signal. Then, the signal processing unit 160 applies high-frequency-amplification to the radio signal so that the radio signal reaches a transmission power level instructed by the control unit 230. The amplified radio signal is supplied to the antenna A through the DUP D, and transmitted toward the base station from the antenna A.

Moreover, the mobile terminals PS1, PS2 each includes a television broadcast receiver (TV broadcast receiver) 300. The TV broadcast receiver 300 receives, for example, one-segment broadcast of terrestrial digital broadcast via an antenna 310, and inputs the reception data of the received one-segment broadcast in the control unit 230. The reception data just after the reception has been scrambled; the control unit 230 uses the decryption key to descramble the reception data.

The control unit 230 separates the reception data of the scrambled one-segment broadcast into a moving image stream and an audio stream, and then, decodes each stream. Then, the control unit 230 displays the decoded moving image signal on a display 290. The control unit 230 also supplies the decoded digital audio signal to the PCM codec 180. The digital audio signal is converted into the analog audio signal by means of the PCM codec 180 and then output from a loudspeaker 200 through a reception speech amplifier 190.

The reference FIGS. 250 and 260 designate a battery and a power supply circuit, respectively. The power supply circuit 260 generates a predetermined operational power supply voltage Vcc based on the battery 250 to supply the voltage Vcc to each circuit unit. The battery 250 is charged by a charging circuit (not shown). The input device 270 is composed of a dial keypad and various kinds of function keys.

Meanwhile, the control unit 230 is provided with a browser function unit 230a, an encryption processing unit 230b, and a reception state monitor unit 230c as its control functions. Among of them, the browser function unit 230a displays source data described in a hypertext markup language (HTML), etc., on the display 280 in a Web page form.

The encryption processing unit 230b obtains an encryption key for descrambling the content data distributed from the mobile broadcast station BS in a scrambled state from the encryption key management unit 92g in the Web server 9B. As mentioned above, the encryption key is supplied, for instance, as attached information of an e-mail. The encryption processing unit 230b uses the obtained encryption key to descramble the content received from the mobile broadcast station BS.

The reception state monitor unit 230c monitors the reception state of the content distributed from the mobile broadcast station BS, and reports the monitoring result to the charging processing unit 92f of the Web server 9B after the termination of the distribution. Regarding the reception situation, an accumulated value of times in which the content has been normally viewed by the mobile terminal, or a ratio of the accumulated value to the total distribution period is used. Next, the operation of the foregoing configuration will be described.

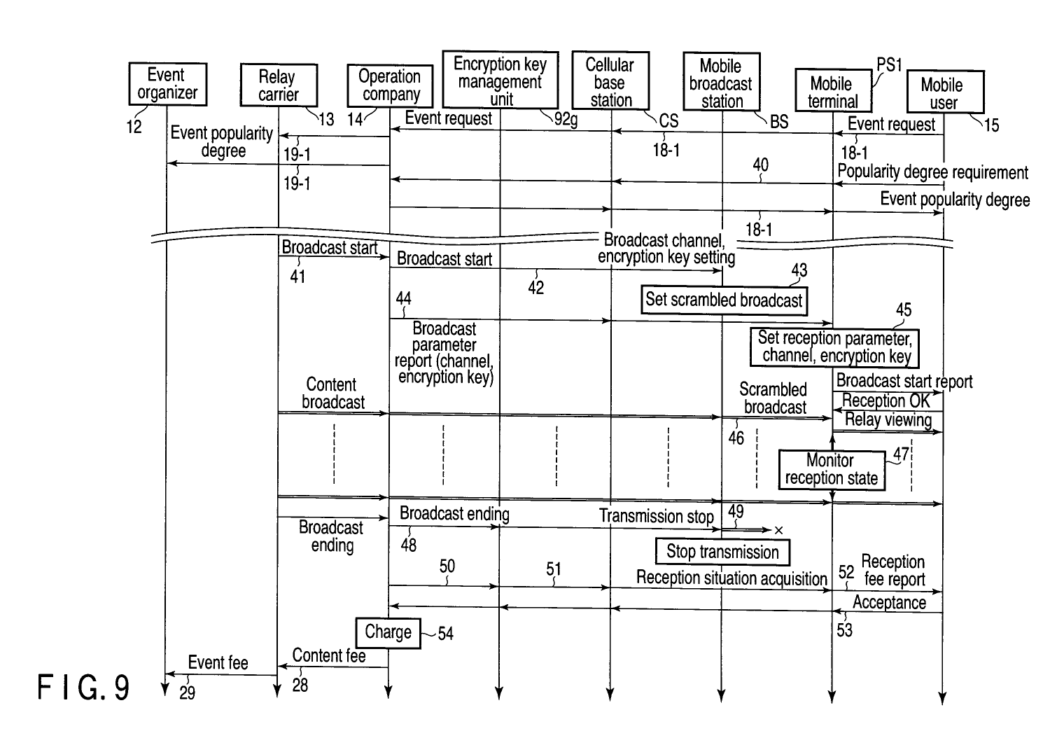

FIG. 9 shows a sequence view illustrating a processing procedure regarding the viewing of the content by the mobile terminal PS1. The procedure for the user of the mobile terminal PS2 to desire the viewing of the content is the same as that of the mobile terminal PS1. The user (mobile user) of the mobile terminal PS1 sends a request (18-1) for an event of which the viewing is desired by the user thereof by using the mobile terminal PS1. The request is reported to the operation company 14 via the cellular base station CS, and the popularity degrees of various events are accumulated. Any of the relay carriers 13 and the event organizer 12 can refer the popularity degrees (19-1) through the Web site. Similarly, the mobile user can refer the popularity degree of the events (19-2) by accessing (40), for example, the site of the operation company 14.

Next, a tender for selecting a relay carrier relaying an event is performed.

Various methods for the tender are considerable. For instance, as described above, a money amount contracting relay business may be set as a tender price, and the distribution right may be granted to the carrier who has presented the cheapest price. Or, the processing procedure may statistically process the evaluations, from the general users, obtained from the previous relay results to evaluate by points, and grant the distribution rights of the events in descending order of point accumulation count values.

When the tender is started, the carriers desiring the event relay express their requests by bidding, and the ranking is disclosed on the Web site. The reference of the ranking of the carriers may be bidding money amounts, or may be evaluation points. When the tender period has passed over, the tender is terminated, the operation company 14 monitors the Web page, and can know which relay carrier has been granted the distribution right of the event. The fact is reported by a selection result report message to the carrier who has been granted the distribution right.

When the selection of the carrier has completed, the relay carrier 13 who has obtained the distribution right to relay the content proceeds various preparations for an announcer, a commentator, a background of an event, performer's information, resume research of athletes, camera work at the relay, etc., to prepare the actual event relay.

Prior to the start of broadcast of the content, the fact of the start is reported, for example, from the relay carrier 13 to the operation company 14 (41).

Then, the encryption key for scrambling is reported from the Web server 9B to the mobile broadcast station BS together with channel information through which the content is broadcasted. The mobile broadcast station BS emits the content to be distributed on the specified channel to a radio section in a state in which the content is scrambled with the encryption key (scrambling broadcast setting) (43).

Along with this, the operation company 14 reports broadcast parameters including the encryption key for descrambling together with the channel information for viewing the content to the mobile terminal PS1 via the cellular base station CS, for example, in an e-mail form (44). When receiving the report, the mobile terminal PS1 sets reception parameters including the encryption key to itself (45) to report the start of broadcast to the mobile user by displaying the parameters on the display 280. When the mobile user responds to this report to perform reception “OK” processing, the descrambling of the scrambled data is started to start the relay viewing.

When the relay viewing of the content broadcast is started, the mobile terminal PS1 starts monitoring the reception state (47). Here, the accumulated value of the period in which the content has been normally viewed is counted. When the event ends, and the relay broadcast terminates, the fact is reported from the relay carrier 13 to the mobile broadcast station BS via the Web server 9B, and transmission waves from the mobile broadcast station BS is stopped (49).

Next, the operation company 14 makes a demand, to the Web server 9B, for acquiring information about charging (50). Then, the Web server 9B sends a message requiring acquisition of the reception situation of the content to the mobile terminal PS1 via the cellular base station CS, and the mobile terminal PS1 receives the message to report the reception fee based on the accumulated value of a normal reception period in a content distribution period to the mobile user (52). After the mobile user accepts the reported fee (53), the fact is returned to the Web server 9B. The operation company 14 then charges the mobile user (54). Thus, the collected viewing fees of the content (28) is paid from the operation company 14 to the relay carrier 13, and the relay carrier 13 pays a part of the fees, as the event fee 29, to the event organizer 12.

As mentioned above, in the second embodiment of the invention, general users including the users of the mobile terminals PS1, PS2 can report the requests for the viewing of the scheduled sportscast relay and the event-cast relay to the carrier. The requests are aggregated on the system side to be disclosed on the Web page. Since the requests to the relay carrier also can be reported, the improvement in skill of the relay carrier can be expected through the effort by the relay carrier itself.

In the second embodiment, since the content to be distributed via the IP network 7 is broadcasted through the mobile broadcast station BS, the mobile terminals PS1, PS2 can view the content, and it is also possible to enjoy the live broadcast of sports, etc., from any place. Further, in the second embodiment, the mobile broadcast station BS has a function of scrambling the content to be distributed, and only the mobile terminals with the decryption keys reported thereto can view the content data to be distributed. That is, to relay the content for the live broadcast via the Web site of the operation company 14, since the content data is scrambled by using the key information, it is possible to allow viewing only specified mobile users but not to allow viewing unspecified number of mobile users at no charge.

In other words, because it is possible for not only the users allowed to view the relay via the IP network 7 but also the users allowed by the mobile broadcast station BS to view the relay, the content distribution can be established as a business, and it is possible to spread the advantage of capable of viewing event-cast even in a mobile environment.

While it is hard for circumstances peculiar to the mobile terminals PS1, PS2 to keep a constant reception state, since, in the second embodiment, the mobile terminals PS1, PS2 monitor the reception situations to report the monitoring results to the system after viewing, it is possible to charge in a paper-view form in a manner where the mobile users have no problem. Thereby, the content distribution system, further enhancing the satisfaction degrees of the viewers, and its mobile terminals can be provided.

The invention is not limited to the specific details and representative embodiments shown and described herein. For instance, the embodiments have described live broadcast content such as the event-cast relay of sports. The invention is not limited to this broadcast content, it is possible to perform TV broadcast depending on the requests from the general users while including programs which have been conventionally edited, produced and broadcasted only by the broadcast station, such as education programs, interviews and quiz programs.

The second embodiment of the invention has described the form in which the event organizer 12 advertises various events. Alternatively, the relay carrier 13 may have an initiative to advertise the event. That is, the relay carrier 13 can thoroughly uniquely organize the event, make a suggestion of content possibly attractive for viewers, and project in a scale corresponding to its own business ability. Since the requests and the degree of the popularity are primitively reported also to the relay carrier 13, the relay carrier 13 can create attractive content with reference to the requests and the degree of the popularity.

That is, it is clearly desired that the business style should not be restricted in a case where the operation company 14 mediates the relationship of the demand and supply among the general users 15 and the event organizer 12, and the style should be expanded in a case where the relay carrier 13 grants the selection right of the content. Entering a content distribution business by a quite new relay carrier with a new concept and a new feeling and exercising its own ability therein is general user's advantages, and also meaningful in an aspect of creating new culture. Producing original content for free not only by the event organizer 12 and the relay carrier 13 but also by the organizer 11 or the general users 15 to advertise themselves can be freely performed by passing through the Web server 9B. In this way, the foregoing embodiments generates advantages of easing to distribute its own content for unspecified large number of peoples as well as advantage of enhancing the degree of satisfaction of the viewers.

It is possible to incorporate the mobile terminals PS1, PS2 with the terminal (PC terminal) of the PC user 8. It is also possible to view the content, which has been requested by using the mobile terminals PS1, PS2, through the mobile terminal PC.

### Third Embodiment

The third embodiment of this invention enables it to participate in this business for the purpose of investment for contents investment by an investment user difference from a general user. The third embodiment establishes the structure which will be invested by the time a tender is performed, when it expects that has many numbers expected user who wants to view the contents.

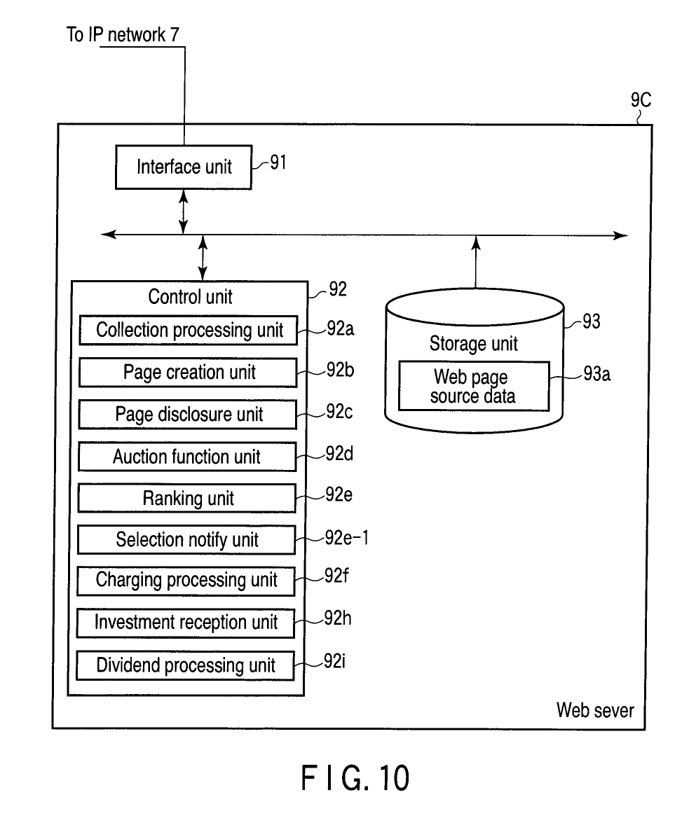

FIG. 10 shows a functional block diagram of the Web server 9C regarding a third embodiment of the invention. In FIG. 10, the same components as those of FIG. 2 are designated by identical symbols and the detailed description will be omitted.

The control unit 92 of the Web server 9C further has an investment reception unit 92h and a dividend processing unit 92i as a processing function regarding the third embodiment of the invention.

The investment reception unit 92h collects events of which the distribution is required from the investment user in forms of event requests, and accepts investment for each item of program content.

The dividend processing unit 92i calculates a dividend money based on the charging data for each item of content acquired by the charging processing unit 92f, and performs processing for paying the dividend money to the investment user who has invested the corresponding-content.

Next, operations of the configuration given above will be described.

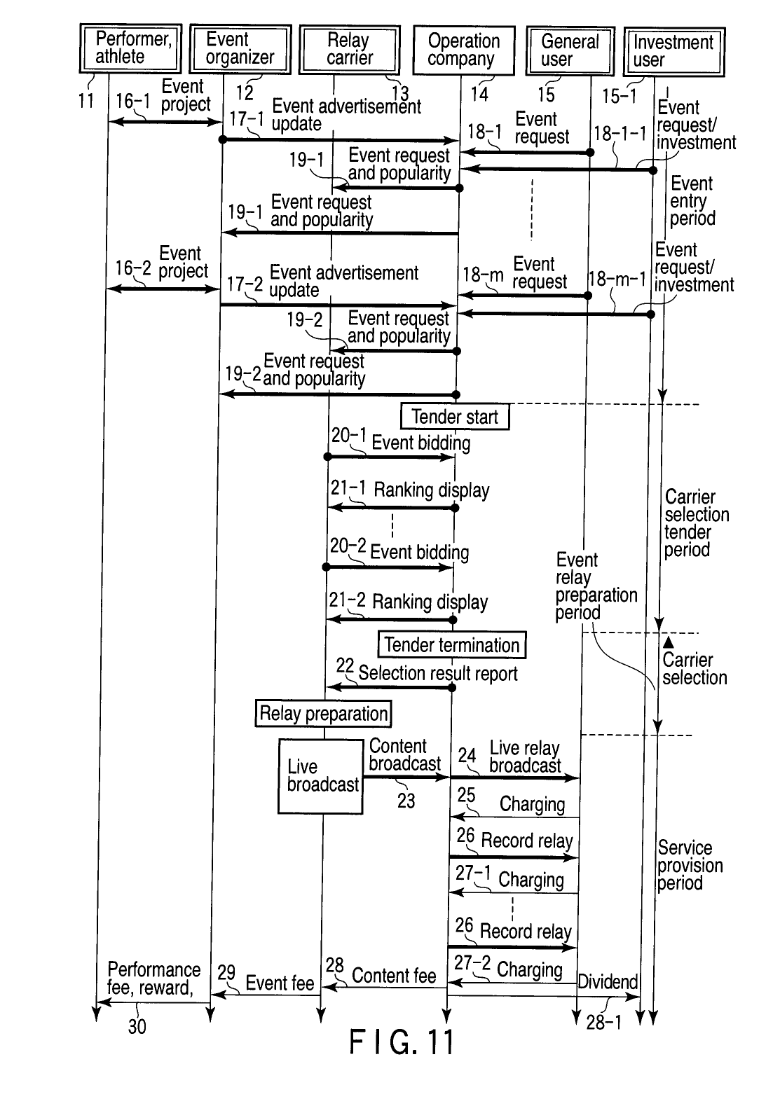

FIG. 11 shows one example of a business flow to be performed in a manner in which a performer and an athlete 11, an organizer 12 promoting each event, a relay carrier 13 producing content, an operation company 14 of a content provider, general users 15 and investment user 15-1 are associated with one another in the content distribution business.

In FIG. 11, the organizer 12 lobbies for the performer and athlete 11 to project an event. The lobbying may be performed directly to the performers, etc. 11, and may transmit/receive messages via the IP network 7 (16-1, 16-2). When the event is projected, an event advertisement update message (17-1) reports the fact to the operation company 14. The operation company 14 registers the intention of performing the projected event in the Web server 9C, and the content of the event is immediately reflected to the Web page.

Meanwhile, general users 15 report requests for events and programs desiring to be broadcasted to the operation company 14 by means of event requests (18-1 to 18-m). The investment user 15-1 report requests for events and programs desiring to be broadcasted to the operation company 14 by means of event requests, or perform investment to events and programs desiring to be broadcasted.

In the method of this investment, when the obligation fees of only the general user who wishes to view are considered as one-lot fixation, an investor shall present the burden of two or more lots at an investment period. According to the number of investment, the one method of paying a dividend in proportion to lot number in which the investor paid a part for the surplus of the amount of money which gathered after TV broadcast was performed, is considered.

Since there are the general user who views contents broadcasted by the contents server 6 and the general user who views to broadcast live, the result which receives a final investment stops settling very much. To this, avoiding that enlarging capacity of the contents server 6 must be continued infinitely also unites, becomes possible by two methods. These two methods are clarifying the term to which a general user can view, and viewing after it carrying out by the ability not doing, or eliminating the contents themselves depending on the case.

The aggregation result of the requests (18-1 to 18-m) is registered in the Web site, and disclosed from the Web page. The general users 15 who have browsed this Web page can similarly enhance needs (popularity degrees) of the events by repeating event requests if event content agreeing with the events is displayed.

While monitoring the degrees of popularities (popularity degrees) for the events (19-1, 19-2), the organizer 12 of some event projects in accordance with the requests from the general users 15. The projected content is similarly registered in the Web site as event advertisements (17-1, 17-2).

The procedure in this way is performed before a fixed period in which the event is actually performed passes, and both the users and carriers can confirm the popularity degree of the event. Next, the tender for selecting a relay carrier relaying the event is performed.

Various ways for the tender are considerable. For instance, as mentioned above, a money amount getting a contract to relay business may be set as a tender price, and a relay carrier presenting the lowest price may be decided as a successful carrier for a distribution right. Or, statistically processing the evaluations, by the users 15, obtained from the previous relay results to evaluate by points, and may grant the distribution right of the event in descending order of point accumulation count values.

In FIG. 11, when the tender is started, the carriers desiring the event relay express their requests by means of the bidding (20-1, 20-2), and the ranking of the bidding is disclosed on the Web site (21-1, 21-2). The reference of the ranking of the carriers may be bidding money amounts, or evaluation points. When the tender period has passed, the tender is terminated; the operation company 14 can know which relay carrier has granted the distribution right of the event by monitoring the Web page. The carrier who has been granted the distribution right is reported the fact by a selection result report message (22).

When the carrier selection is terminated, the relay carrier 13 who has been granted the distribution right to relay the content prepares for information of an announcer, a commentator, a background of the event, and performers, history research of athletes, camera work at the relay, etc., and prepares for actual event relay.

When the event is held, broadcast content (23) is broadcasted or distributed to the general users 15 via the IP network 7. Moreover, the content is broadcasted or distributed only to registered general users 8-1 to 8-n through IP network 7 by a following method. The following method is using a distribution server and passing streaming data by a unicast to the registered general user 8-1-8-n. Here, a distribution server is a part of function of content server 6. Moreover, a unicast is distributing data to general users 8-1 to 8-n from a distribution server by 1:1. Although the distribution form is basically live broadcast, the form may be on-demand distribution through the content server 6. That is, the general users 15 not only can view the content through actual live broadcast (24) but also can view the content from the content server 6 when they feel like it.

The operation company 14 grasps the number of the viewers for each item of content. More practically, the general users 15 register themselves in the distribution system in advance, and then, the operation company 14 grasps that from what time to what time in the content broadcast hour the users 15 have viewed the content based on their login hours. Thereby, the operation company 14 can calculate indexes indicating whether or not the users 15 get bored with the content in midstream, this indexes are reflected to the points of the carriers.

Comparing the advance popularity degree of the event with the number of actual viewers enables the comparison result to be used as one of items of the evaluation data of the relay carrier 13. For instance, if the number of the viewers is small even though the carrier has been ballyhooed, there is possibility that the event itself or the carrier 13 has a problem. In such a case, the operation company 14 should degrade the evaluation point of the carrier 13 who has contracted for the content distribution, and otherwise, the operation company 14 should promote the carrier 13.

The users 15 who have viewed the content are charged, for example, with metered rate charging for each actual live broadcast, or for recorded broadcast (25, 27-1, and 27-2). The operation company 14 gathers once the fees charged from the users 15, and pays a content fee (28) to the relay carrier 13, an event fee (29) to the event organizer, performance fees and rewards (30) for the performers and athletes 11, respectively. That is, depending on the aggregation result of the number of the viewers after the end of the event, the operation company 14 pays the content fee (28) to the relay carrier 13, and the relay carrier 13 pays a part of a cost as the event fee (29) to the event organizer 12. Further, the event organizer 12 pays the performance fees and rewards (30) to the performers and the athletes 11 from among the money amount, including entrance fees of attendances, other than the fees due to the broadcast. Thus, the rewards depending on the provided services are distributed to each party and person.

On the other hand, the operation company 14 calculates a dividend in proportion to lot number which the investment user 15-1 paid, based on a part for the surplus by the total result of the charge collected from the general user 15, and a dividend is fed back to the investment user 15-1 (28-1). Conversely, if an insufficiency arises in the amount of money which gathered, the part will be paid by the investment user 15-1, the dividend of minus will be imposed or the amount of money paid for investment will be maintained by the state where it has collected.

In addition, about the time on the flow about investment or a dividend, and structure, various ways can complete easily.

As described above, in the third embodiment, the dividend which balances it according to the viewing situation of contents can be obtained for the investment user 15-1. On the other hand, for the operation company 14, since the amount of money which will gather if many TV viewers gather as a result of performing actual TV broadcast also mounts up, a part for the surplus is feed back to the investment user 15-1 in the form of a dividend. For this reason, the participant in business can be increased and increase of market size is attained.

In addition, not only the third embodiment but a general user not only collects the events which require distribution, respectively, but other methods are considered. until it raises the request to the event predicted that other methods have many viewing candidates and a distribution carrier is decided, etc. it is that only lots invests two or more unit amounts of investment as lot as an investment period until a fixed period passes. That is, investment is made possible for every event distribution, and the mechanism of finally returning to an investor the amount of money which was an actual distribution result, and gathered when many TV viewers view for pay also becomes possible by applying this system.

Moreover, according to the third embodiment, the function of the usual internet is also utilizable for the maximum by two or more methods. These methods are stretching a link to the detailed site for PR, etc, in order that a general user may raise expectation and comment in chat form, etc, or may heap up the event. Moreover, these methods are performed at the period until the event which requires distribution is performed, and live broadcast midst of an event.

### Other Embodiment

The invention is not limited to each of the aforementioned embodiments. While the second embodiment of the invention has described an example distributing the content to the mobile terminals by using so-called one-segment broadcast compliant with integrated services digital broadcasting-terrestrial (ISDB-T), the invention is not limited to this example, it is easily possible to distribute the content by using a mobile TV system such as a media forward Link only (FLO), a digital video broadcasting-handheld (DVB-H), or a ISDB-T for mobile multimedia (ISDBT-mm) depending on the application of the second embodiment.

While each of the aforementioned embodiments has described about an example separately providing a content server and a Web server, one server may have both functions of the content server and of the Web server. One server may be managed by Operation Company as management apparatus. While the second embodiment has described an example separately providing the content server, the Web server and the mobile broadcast station, one apparatus may have the functions of the content server, of the Web server, and of the mobile broadcast. One apparatus may be managed by Operation Company as management apparatus.

Moreover, The invention may be the combination of the second embodiment and the third embodiment.

In an implementation phase, this invention may be embodied in various forms without departing from the spirit or scope of the general inventive concept thereof. Various types of the invention can be formed by appropriately combining a plurality of constituent elements disclosed in the foregoing embodiments. Some of the elements, for example, may be omitted from the whole of the constituent elements shown in the embodiments mentioned above.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A content distribution system comprising a terminal of a content distributor configured to distribute content to a network, a plurality of terminals configured to receive and reproduce content distributed on a network by the content distributor, and a management apparatus configured to perform operation management of the content, wherein
the management apparatus comprises:
a collector configured to collect requests via the network from users of the plurality of terminals, the requests is requests of events of which the distribution is required;
a list generator configured to aggregate the collected requests for each event to generate a list;
a disclosure unit configured to disclose the list on a site on the network for a predetermined period;
a reception unit configured to receive a request for distributions from a plurality of content distributors via the site for each content included in the list;
a selector configured to select a content distributor to which a distribution right is granted from among the plurality of content distributors for each content included in the list based on a predetermined conditions; and
a reporter configured to report a selection result by the selector to content distributors with the distribution rights granted thereto.

2. A management apparatus connected to a plurality of terminals configured to receive and reproduce content distributed on a network by a content distributor and perform operation management of the content comprising:
a collector configured to collect requests via the network from users of the plurality of terminals, the requests is requests of events of which the distribution is required;
a list generator configured to aggregate the collected requests for each event to generate a list;
a disclosure unit configured to disclose the list on a site on the network for a predetermined period;
a reception unit configured to receive a request for distributions from a plurality of content distributors via the site for each content included in the list;
a selector configured to select a content distributor to which a distribution right is granted from among the plurality of content distributors for each content included in the list based on a predetermined conditions; and
a reporter configured to report a selection result by the selector to content distributor with the distribution right granted thereto.

3. The apparatus according to claim 2, wherein
the reception unit receives the request for distributions by a bit prices to the distribution right of the content in an auction form; and
the selector bits the distribution right to a content distributor who has presented the cheapest price.

4. The apparatus according to claim 2, wherein
the collector collects evaluation information of distributed content via the network;
further comprising:
a ranking unit configured to rank the plurality of content distributors based on a result in which the collected evaluations are statistically processed;
wherein
the disclosure unit discloses a result of the ranking on the site.

5. The apparatus according to claim 2, further comprising:
a charging unit configured to charge to a user who has viewed the content.

6. The apparatus according to claim 5, further comprising:
a processor configured to calculate a reward money amount to a content distributor who has produced corresponding-content based on charging data for each content obtained by the charging unit to perform processing for paying the money amount to the content distributor.

7. The apparatus according to claim 2, further comprising:
an on-demand distribution server configured to record the distributed content to distribute the content on demand in response to a request from the user.

8. The apparatus according to claim 5, further comprising:
a investment reception unit configured to receive investment to the content by the user; and
a dividend processing unit configured to calculate a dividend money for the user who has invested the corresponding-content based on charging data for each item of content acquired by the charging unit to perform processing for paying the dividend money to the user.

9. The apparatus according to claim 2, further comprising:
a mobile distribution unit configured to distribute content to be provided from the content distributor to a mobile terminal of a request origin via the network;
a scrambler configured to scramble content to be distributed by the mobile distribution unit for keeping a secret on the network; and
a key reporter configured to report key information for descrambling to a mobile terminal of the request origin.

10. The apparatus according to claim 9, further comprising:
an acquisition unit configured to acquire a reception situation of the content from a mobile terminal with the distribution of the content received thereby; and
a mobile charging unit configured to charge to a user of a mobile terminal of an acquisition origin with metered rate charging corresponding to the reception situation.

11. The apparatus according to claim 10, further comprising:
a processor configured to calculate an award money amount for a content distributor who has produced the corresponding-content based on charging data for each item of content acquired by the mobile charging unit to perform processing for paying the money amount to the content distributor.

12. The apparatus according to claim 9, wherein
the key reporter attaches the key information to an e-mail to be distributed to the mobile terminal of the request origin prior to the distribution of the content.

13. The apparatus according to claim 10, further comprising:
a investment reception unit configured to receive investment to the content by the user; and
a dividend processing unit configured to calculate a dividend money for the user who has invested the corresponding-content based on charging data for each item of content acquired by the mobile charging unit to perform processing for paying the dividend money to the user.

14. A mobile terminal which is connectable to a management apparatus configured to perform operation management of content distributed on the network by a content distributor, via the network, comprising:
a request transmitter configured to transmit a request to the management apparatus, the request is a request of an event of which the distribution is required;
a key acquisition unit configured to acquire, from the management apparatus, key information for descrambling content to be scrambled and distributed; and
a decoder configured to decode the content by using the acquired key information.

15. The terminal according to claim 14, further comprising;
a reception situation reporter configured to report a reception situation of the content to be distributed to the management apparatus.
